(19) United States
(12) Patent Application Publication
(10) Pub. No.: US 2026/0246542 A1
(43) Pub. Date: Aug. 20, 2026

(54) ELECTRONIC DEVICE FOR PERFORMING WIRELESS COMMUNICATION USING PLURALITY OF ANTENNAS, AND OPERATION METHOD THEREFOR

(71) Applicant: SAMSUNG ELECTRONICS CO., LTD., Suwon-si (KR)

(72) Inventors: Seongju LEE, Suwon-si (KR); Kukjeong KIM, Suwon-si (KR); Jaemoon CHA, Suwon-si (KR)

(21) Appl. No.: 19/639,816

(22) Filed: Apr. 6, 2026

Related U.S. Application Data
(63) Continuation of application No. PCT/KR2024/016115, filed on Oct. 23, 2024.

(30) Foreign Application Priority Data
Oct. 27, 2023 (KR) 10-2023-0145491
Nov. 27, 2023 (KR) 10-2023-0167162

(51) Int. Cl. H04B 17/12; H04B 17/21; H04B 17/318; H04W 24/10; H04W 28/16

(52) U.S. Cl. CPC H04B 17/12; H04B 17/221; H04B 17/318; H04W 24/10; H04W 28/16

(57) ABSTRACT

An electronic device may include multiple antennas, at least one processor, comprising processing circuitry, and a memory, wherein the memory stores instructions which, when executed individually and/or collectively by the at least one processor, cause the electronic device to: confirm a tuner related to a first antenna using a first tuning method; identify wireless communication performance of the multiple antennas in a state in which the tuner related to the first antenna is configured based on the first tuning method; and change the tuning method of the first antenna to a second tuning method if the difference value between the wireless communication performance of the first antenna and the wireless communication performance of a second antenna satisfies a designated first switching condition.

### CROSS-REFERENCE TO RELATED APPLICATIONS

This application is a continuation of International Application No. PCT/KR2024/016115 designating the United States, filed on Oct. 23, 2024, in the Korean Ministry of Intellectual Property Receiving Office and claiming priority to Korean Patent Application Nos. 10-2023-0145491, filed on Oct. 27, 2023, and 10-2023-0167162, filed on Nov. 27, 2023, in the Korean Ministry of Intellectual Property, the disclosures of each of which are incorporated by reference herein in their entireties.

### BACKGROUND

### Field

The disclosure relates to a device and a method for performing wireless communication using a plurality of antennas in an electronic device.

### Description of Related Art

An electronic device may perform wireless communication with an external electronic device via a plurality of antennas. Electronic devices may include a plurality of antennas (e.g., antenna structures or antenna modules) to satisfy the communication quality (e.g., throughput) desired by a user through wireless communication or to support a relatively wide frequency band of wireless communication. For example, the wireless communication may include at least one of long-term evolution (LTE) communication or 5G communication (or new radio (NR) communication).

The above information may be provided as related art to aid in understanding the disclosure. No assertion or determination is made as to whether any of the descriptions above are prior art related to the disclosure.

When an electronic device uses a plurality of antennas, it may configure a tuner associated with each antenna, taking into account the influence of interference between the plurality of antennas. For example, the electronic device may configure a tuner associated with a first antenna (e.g., the main antenna) among a plurality of antennas, taking into account the wireless communication performance (e.g., reception performance) of a second antenna (e.g., a multi-input multi-output (MIMO) antenna) physically adjacent to the first antenna. To maintain isolation between the first antenna and the second antenna, the electronic device may configure the tuner associated with the first antenna with a configuration value (e.g., a tuning code) selected based on the isolation of the first antenna and the second antenna, rather than an optimal configuration value (e.g., a tuning code) considering the wireless communication performance of the first antenna.

When the electronic device performs wireless communication via the plurality of antennas, a reception imbalance (RX imbalance) phenomenon may occur, in which the wireless communication performance (e.g., reception performance) differs among the antennas. The electronic device may perform wireless communication using a plurality of antennas even when the wireless communication performance of a specific antenna does not affect the wireless communication performance of the electronic device due to the reception imbalance phenomenon. For example, the reception imbalance phenomenon may occur due to the location or grip state of the electronic device, or design limitations of the reception path associated with each antenna.

The electronic device may perform wireless communication using a plurality of antennas even when the wireless communication performance of a specific reception path is degraded due to hardware damage.

The electronic device may perform wireless communication unnecessarily using a plurality of antennas due to software limitations associated with the operation of the plurality of antennas.

### SUMMARY

Embodiments of the disclosure provide a device and a method for improving wireless communication performance in an electronic device equipped with a plurality of antennas.

According to an example embodiment, an electronic device may include: a plurality of antennas physically arranged adjacent to each other, at least one processor, comprising processing circuitry, operatively connected to the plurality of antennas, and memory storing instructions. According to an example embodiment, the instructions, when executed by at least one processor individually and/or collectively, cause the electronic device to: identify at least one of received signal quality of the plurality of antennas or state information of reception paths associated with the plurality of antennas; configure a tuner associated with a first antenna among the plurality of antennas using a first tuning method that configures a tuner based on at least one of the identified received signal quality of the plurality of antennas and/or the identified state information of reception paths of the plurality of antennas; identify at least one of the received signal quality and/or the state information of reception paths of the plurality of antennas in a state in which the tuner associated with the first antenna is configured based on the first tuning method; change the tuning method of the first antenna to a second tuning method that configures a tuner based on at least one of received signal quality of the first antenna or state information of a reception path of the first antenna based on a difference value in at least one of received signal quality and/or state information of a reception path between the first antenna and the second antenna satisfying a designated first switching condition; and configure the tuner associated with the second antenna based on the second tuning method.

According to an example embodiment, a method of operating an electronic device including a plurality of antennas physically arranged adjacent to each other may include: identifying at least one of received signal quality and/or state information of reception paths of the plurality of antennas; configuring a tuner associated with a first antenna among the plurality of antennas using a first tuning method that configures a tuner based on at least one of the identified received signal quality and/or the identified state information of reception paths of the plurality of antennas; identifying at least one of the received signal quality and/or the state information of reception paths of the plurality of antennas in a state in which the tuner associated with the first antenna is configured based on the first tuning method; changing the tuning method of the first antenna to a second tuning method that configures a tuner based on at least one of received signal quality and/or state information of a reception path of the first antenna based on a difference value in at least one of received signal quality and/or state information of a reception path between the first antenna and the second antenna satisfying a designated first switching condition; and configuring the tuner associated with the second antenna based on the second tuning method.

According to an example embodiment, a non-transitory computer-readable storage medium (or computer program product) storing one or more programs may be described. According to an example embodiment, the one or more programs may include instructions that, when executed by at least one processor, comprising processing circuitry, individually and/or collectively, of an electronic device, cause the electronic device to perform operations comprising: identifying at least one of received signal quality and/or state information of reception paths of a plurality of antennas, configuring a tuner associated with a first antenna among the plurality of antennas physically adjacent to each other using a first tuning method that configures a tuner based on at least one of the received signal quality or the state information of reception paths of the plurality of antennas, identifying at least one of the received signal quality and/or the state information of reception paths of the plurality of antennas in a state in which the tuner associated with the first antenna is configured based on the first tuning method, changing the tuning method of the first antenna to a second tuning method that configures a tuner based on at least one of received signal quality and/or state information of a reception path of the first antenna based on a difference value in at least one of received signal quality and/or state information of a reception path between the first antenna and the second antenna satisfying a designated first switching condition, and configuring the tuner associated with the second antenna based on the second tuning method.

According to an example embodiment of the disclosure, an electronic device including a plurality of physically adjacent antennas may improve the wireless communication performance of a first antenna by configuring a tuner associated with the first antenna based on the wireless communication performance of the first antenna when the wireless communication performance (e.g., reception performance) of a second antenna (e.g., MIMO antenna) is lower than the wireless communication performance of the first antenna (e.g., main antenna) by a designated reference difference or more (e.g., RX imbalance).

According to an example embodiment, an electronic device including a plurality of physically adjacent antennas may deactivate a reception path associated with a second antenna when configuring a tuner associated with the first antenna based on the wireless communication performance of the first antenna, thereby reducing unnecessary power consumption.

In addition, various effects that are directly or indirectly understood through this disclosure may be provided.

The effects obtainable from the disclosure are not limited to the effects described above, and other effects not mentioned will be clearly understood by those skilled in the art to which the disclosure belongs from the following description.

### BRIEF DESCRIPTION OF THE DRAWINGS

In connection with the description of the drawings, the same or similar reference numerals may be used for the same or similar components. Further, the above and other aspects, features and advantages of certain embodiments of the present disclosure will be more apparent from the following detailed description, taken in conjunction with the accompanying drawings, in which:

FIG. 1 is a block diagram of an example electronic device in a network environment according to various example embodiments.

FIG. 2 is a diagram illustrating a front view of an example electronic device according to various example embodiments.

FIG. 3 is a block diagram illustrating an example configuration of an example electronic device equipped with a plurality of antennas, which are physically adjacent to each other, according to various example embodiments.

FIG. 4 is a flowchart illustrating example operations for changing the tuning method of a first antenna in an electronic device according to various example embodiments.

FIG. 5 is a flowchart illustrating example operations for identifying the wireless communication performance of a plurality of antennas in an electronic device according to various example embodiments.

FIG. 6 is a flowchart illustrating example operations for changing the tuning method of a first antenna in an electronic device according to various example embodiments.

### DETAILED DESCRIPTION

Hereinafter, various example embodiments will be described in greater detail reference to the attached drawings.

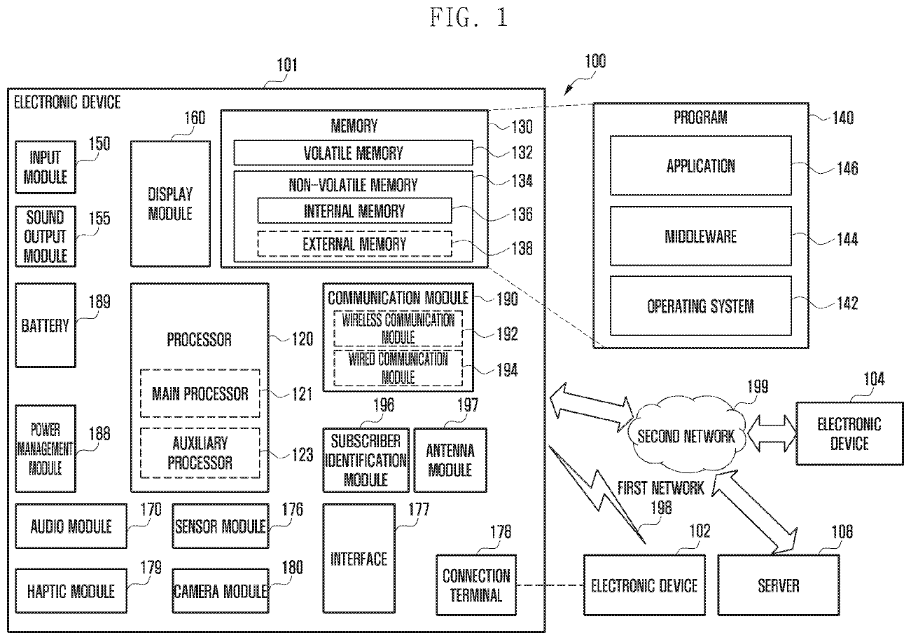

FIG. 1 is a block diagram illustrating an example electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one of the components (e.g., the connecting terminal 178) may be omitted from the electronic device 101, or one or more other components may be added in the electronic device 101. In various embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121. Thus, the processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence model is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of Ims or less) for implementing URLLC. According to an embodiment, the subscriber identification module 196 may include a plurality of subscriber identification modules. For example, the plurality of subscriber identification modules may store different subscriber information.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form high frequency (e.g., a mm Wave) antenna module. According to an embodiment, the high frequency (e.g., the mmWave) antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band. For example, the plurality of antennas may include patch array antennas and/or dipole array antennas. For example, the plural antennas may include patch array antennas and/or dipole array antennas.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

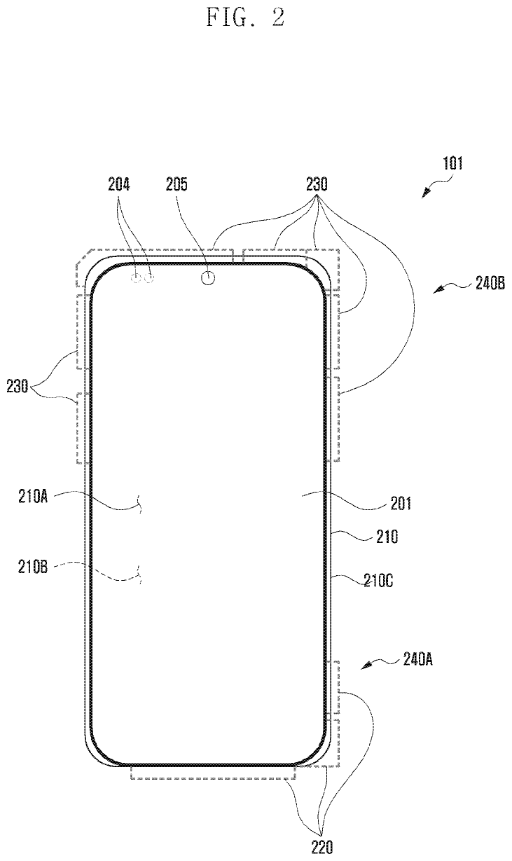

FIG. 2 is a diagram illustrating a front view of an example electronic device according to various example embodiments. For example, the electronic device 101 in FIG. 2 may be at least partially similar to the electronic device 101 in FIG. 1 or may further include various embodiments of the electronic device.

According to an embodiment referring to FIG. 2, the electronic device 101 may include a housing 210 including a first surface (or front surface) 210A, a second surface (or rear surface) 210B, and a lateral surface 210C enclosing the space between the first surface 210A and the second surface 210B. According to an embodiment, the housing 210 may also refer to a structure forming a portion of the first surface 210A, the second surface 210B, and the lateral surface 210C in FIG. 2. For example, the first surface 210A may be formed by a front plate having at least a portion that is substantially transparent (e.g., a glass plate including various coating layers, or a polymer plate). The second surface 210B may be formed by a substantially opaque rear plate. For example, the rear plate may be formed of coated or colored glass, ceramic, polymer, metal (e.g., aluminum, stainless steel (STS), or magnesium), or a combination of at least two of the aforementioned materials.

For example, the lateral surface 210C may be formed by a lateral bezel structure (or “lateral member”) that is coupled to the front plate and rear plate and includes a metal and/or polymer. For example, the rear plate and lateral bezel structure may be formed integrally and may include the same material (e.g., a metal such as aluminum).

According to an embodiment, the electronic device 101 may include at least one of a display 201, a sensor module 204, or a camera module 205. For example, although not shown, the electronic device 101 may further include at least one of an input device (e.g., a microphone), an audio output device (e.g., a speaker), a key input device (e.g., a button), an indicator, or a connector. For example, the input device, the audio output device, and the connector may be disposed in the inner space of the electronic device 101 and exposed to the external environment through at least one hole formed in the housing 210. For example, the hole formed in the housing 210 may be used for both the input device and the audio output device.

According to an embodiment, the display 201 may be visible through a significant portion of the front plate of the first surface 210A. For example, the display 201 may be coupled to or disposed adjacent to a touch detection circuit, a pressure sensor capable of measuring the intensity (pressure) of a touch, and/or a digitizer capable of detecting a magnetic field-type stylus pen.

According to an embodiment, the sensor module 204 may include at least one sensor and generate an electrical signal or data value corresponding to an internal operating state of the electronic device 101 or an external environmental state. For example, the sensor module 204 may include a first sensor module 204 (e.g., a proximity sensor) and/or a second sensor module (not shown) (e.g., a fingerprint sensor) disposed on the first surface 210A of the housing 210, and/or a third sensor module (e.g., an HRM sensor) disposed on the second surface 210B of the housing 210. A fingerprint sensor may be disposed on the first surface 210A of the housing 210. The fingerprint sensor (e.g., an ultrasonic or optical fingerprint sensor) may be disposed below the display 201 in the first surface 210A. The electronic device 101 may further include at least one sensor module (not shown), such as a gesture sensor, a gyro sensor, a pressure sensor, a magnetic sensor, an acceleration sensor, a grip sensor, a color sensor, an infrared (IR) sensor, a biometric sensor, a temperature sensor, a humidity sensor, or an illuminance sensor 204.

According to an embodiment, the camera modules 205 may include a first camera module 205 disposed on the first surface 210A of the electronic device 101. For example, the electronic device 101 may include a second camera module and/or a flash disposed on the second surface 210B. The camera modules 205 may include one or more lenses, an image sensor, and/or an image signal processor. The flash may include a light-emitting diode or a xenon lamp. For example, two or more lenses (wide-angle and telephoto lenses) and image sensors may be arranged on one surface of the electronic device 101.

According to an embodiment, the electronic device 101 may include conductive portions 220 and/or 230 used as antennas (or antenna structures). For example, conductive portions 220 that are physically adjacent to each other in a first region 240A may be separated from each other by at least one segment (e.g., a non-conductive portion). For example, conductive portions 230 that are physically adjacent to each other in a second region 240B may be separated from each other by at least one segment (e.g., a non-conductive portion). For example, each conductive portion 220 or 230 may be used as a different antenna. For example, at least two conductive portions 220 or 230 may be used as a single antenna.

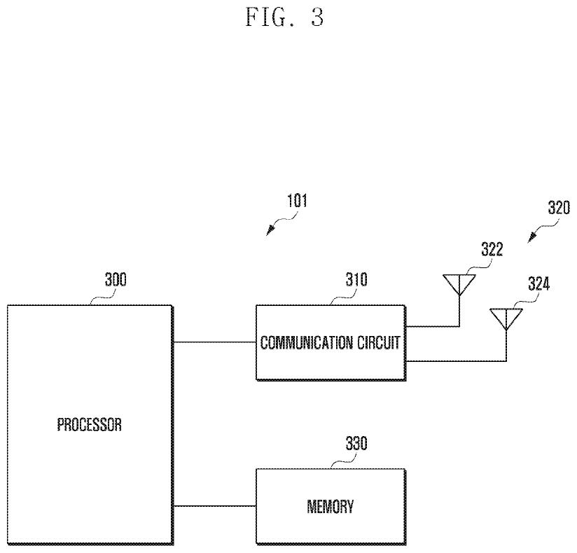

FIG. 3 is a block diagram illustrating an example configuration of an electronic device including a plurality of antennas, which are physically adjacent to each other, according to various example embodiments. For example, the electronic device 101 in FIG. 3 may be at least partially similar to the electronic device 101 in FIG. 1 or FIG. 2, or may further include various embodiments of the electronic device.

According to an embodiment referring to FIG. 3, the electronic device 101 may include at least one of a processor (e.g., including processing circuitry) 300, a communication circuit (or communication circuitry) 310, a plurality of antennas 320 (e.g., 322, 324), and/or memory 330. According to an embodiment, the processor 300 may be substantially identical to the processor 120 (e.g., a communication processor) in FIG. 1, or may be included in the processor 120 and thus a detailed description may not be repeated here. The communication circuit 310 may be substantially identical to the wireless communication module 192 in FIG. 1, or may be included in the wireless communication module 192. The plurality of antennas 320 may be substantially identical to the antenna module 197 in FIG. 1 or the conductive patterns 220 in FIG. 2, or may be included in the antenna module 197 or the conductive patterns 220. The memory 330 may be substantially identical to the memory 130 in FIG. 1, or may be included in the memory 130. For example, although the plurality of antennas 320 in FIG. 3 include a first antenna 322 and a second antenna 324, they may also include three or more antennas.

According to an embodiment, the plurality of antennas 320 may include antennas (e.g., the conductive patterns 220 in FIG. 2), which are physically adjacent to each other. For example, the physically adjacent antennas may include antennas (e.g., the first antenna 322 and the second antenna 324) positioned within a designated distance, among the antennas disposed in the electronic device 101. For example, the first antenna 322 may be an antenna (e.g., the main antenna) with the best wireless communication performance, among the plurality of antennas 320, and may vary based on the wireless environment (e.g., the grip state) of the electronic device 101. For example, the first antenna 322 may be used for transmitting and receiving signals. For example, the second antenna 324 may be an auxiliary antenna for multi-antenna communication (e.g., multi-input multi-output (MIMO) or diversity) and may include an antenna physically adjacent to the first antenna 322. For example, the second antenna 324 may be used for receiving signals.

According to an embodiment, the processor 300 may include various processing circuitry and control at least one of the communication circuit 310 or the memory 330 that is operatively, functionally, and/or electrically connected thereto. For example, the processor 300 may include at least one processor that includes processing circuitry.

According to an embodiment, the processor 300 may control the communication circuit 310 to perform wireless communication via the plurality of antennas 320. For example, the processor 300 may control the communication circuit 310 to perform wireless communication in the state where a configuration value (e.g., tuning code) of the tuner associated with the first antenna 322 is configured based on a first tuning method. For example, the first tuning method may include an active detuning method, which configures the tuner associated with the first antenna 322 in consideration of at least one of the wireless communication performances of the first antenna 322 and the second antenna 324 or the isolation between the first antenna 322 and the second antenna 324. For example, the tuner associated with the first antenna 322, which is configured based on the first tuning method, may be configured to maintain isolation from the second antenna 324 at a designated value (e.g., approximately 30 dB). For example, the tuner associated with the first antenna 322 may be configured to a fixed value when using the first tuning method. For example, wireless communication is a communication method utilizing a plurality of antennas and may include at least one of long-term evolution (LTE) or new radio (NR).

According to an embodiment, when performing wireless communication via the plurality of antennas 320, the processor 300 may identify the wireless communication performances of the respective antennas (e.g., the first antenna 322 and the second antenna 324). For example, when the electronic device 101 is in a weak electric field state, the processor 300 may periodically identify the wireless communication performances of the respective antennas (e.g., the first antenna 322 and the second antenna 324) based on a designated first period. For example, the designated first period may be configured based on at least one of a period (e.g., approximately 200 ms) for updating a configuration value (e.g., tuning code) of a tuner or a paging period (e.g., approximately 320 ms or approximately 640 ms). For example, the weak electric field state is a state in which the wireless communication performance of the electronic device 101 satisfies designated weak electric field conditions, and may include a state in which the strength of a wireless signal received by the electronic device 101 is lower than a designated reference strength. For example, the wireless communication performance of the electronic device 101 may be identified based on the wireless communication performances of the plurality of antennas 320. For example, wireless communication performance may include at least one of the quality of a signal received through each antenna (e.g., the first antenna 322 or the second antenna 324) during a designated period of time, or state information of a reception path associated with each antenna. For example, signal quality may include at least one of a received signal strength indicator (RSSI), a reference signal received quality (RSRQ), a reference signal received power (RSRP), a signal to noise ratio (SNR), a signal to interference and noise ratio (SINR), a quality of service (QoS), or a bit error rate (BER). For example, state information of a reception path associated with an antenna may include a voltage standing wave ratio (VSWR).

According to an embodiment, the processor 300 may identify whether a reception imbalance phenomenon occurs based on the wireless communication performance of the plurality of antennas 320. For example, if the difference value in wireless communication performance between the first antenna 322 and the second antenna 324 satisfies the designated first switching condition, the processor 300 may determine that a reception imbalance phenomenon has occurred. For example, the state in which the designated first switching condition is satisfied may include a state in which the wireless communication performance of the second antenna 324 is lower than the wireless communication performance of the first antenna 322 by a designated reference difference or more.

According to an embodiment, if it is determined that a reception imbalance has occurred, the processor 300 may change the tuning method of the tuner associated with the first antenna 322 to a second tuning method. For example, the second tuning method may include an active tuning method that configures the tuner associated with the first antenna 322 by considering only the wireless communication performance of the first antenna 322.

For example, if the processor 300 changes the tuning method of the tuner associated with the first antenna 322 to the second tuning method, the processor 300 may periodically update, based on the designated first period, the configuration value (e.g., tuning code) of the tuner associated with the first antenna 322 based on the state information of a reception path (e.g., VSWR) associated with the first antenna 322. For example, the state information of a reception path associated with the first antenna 322 may be measured (or identified) based on a designated second period (e.g., approximately 50 ms) that is different from the designated first period.

According to an embodiment, when it is determined that a reception imbalance phenomenon has occurred, the processor 300 may control the communication circuit 310 to deactivate a reception path associated with the second antenna 324. For example, deactivating the reception path may include a series of operations of cutting off the power supply to at least one circuit of the reception path.

According to an embodiment, if it is determined that a reception imbalance phenomenon has occurred, the processor 300 may identify whether a designated second switching condition is satisfied based on the wireless communication performance of the second antenna 324. For example, the state in which the designated second switching condition is satisfied may indicate a state in which the wireless communication performance of the second antenna 324 is determined not to affect the wireless communication performance of the electronic device 101. For example, the state in which the designated second switching condition is satisfied may include a state in which the RSRP of the second antenna 324 is lower than or equal to a designated reference RSRP (e.g., approximately −125 dBm) and the SNR of the second antenna 324 is lower than or equal to a designated reference SNR (e.g., approximately 0). For example, the state in which the designated second switching condition is satisfied may include a state in which the rank indicator or rank index (RI) continuously or periodically transmitted by the electronic device 101 to the network is configured to a designated first configuration value (e.g., “1”). For example, the RI of the designated first configuration value may include a state in which signals transmitted through the plurality of antennas are recognized as signals transmitted from a single antenna.

According to an embodiment, when the processor 300 determines that a reception imbalance phenomenon has occurred and the designated second switching condition is satisfied, the processor 300 may change the tuning method of the tuner associated with the first antenna 322 to the second tuning method. For example, when the tuning method of the tuner associated with the first antenna 322 is changed to the second tuning method, the processor 300 may periodically update, based on the designated first period, the configuration value (e.g., tuning code) of the tuner associated with the first antenna 322 based on the state information of a reception path (e.g., voltage standing wave ratio (VSWR)) associated with the first antenna 322. For example, the state information of a reception path associated with the first antenna 322 may be measured (or identified) based on a designated second period (e.g., about 50 ms) that is different from the designated first period.

According to an embodiment, when it is determined that a reception imbalance phenomenon has occurred and that the designated second switching condition is satisfied, the processor 300 may control the communication circuit 310 to deactivate the reception path associated with the second antenna 324. For example, the deactivating of the reception path may include a series of operations of cutting off the power supply to at least one circuit of the reception path.

According to an embodiment, the communication circuit 310 may support wireless communication between the electronic device 101 and an external electronic device (e.g., the electronic device 102 or 104 in FIG. 1) through the plurality of antennas 320. For example, the communication circuit 310 may include at least one tuner for controlling at least one of the impedance or frequency characteristics of each of the plurality of antennas 320. For example, the tuner may include at least one of an impedance tuner for impedance matching of the antenna or an aperture tuner for controlling the frequency characteristics of the antenna.

According to an embodiment, the memory 330 may store various data used by at least one component (e.g., the processor 300 or the communication circuit 310) of the electronic device 101. For example, the memory 330 may store various instructions that may be individually or collectively executed by the processor 300 (e.g., at least one processor).

According to an example embodiment, an electronic device (e.g., the electronic device 101 in FIG. 1, FIG. 2, or FIG. 3) may include a plurality of antennas (e.g., the antenna module 197 in FIG. 1 or the plurality of antennas 320 in FIG. 3) physically arranged adjacent to each other, at least one processor (e.g., the processor 120 in FIG. 1 or the processor 300 in FIG. 3), including processing circuitry, operatively connected to the plurality of antennas, and memory (e.g., the memory 130 in FIG. 1 or the memory 330 in FIG. 3) storing instructions. According to an example embodiment, the instructions, when executed by the at least one processor individually and/or collectively, to cause the electronic device to configure a tuner associated with a first antenna (e.g., the first antenna 322 in FIG. 3) among the plurality of antennas using a first tuning method that configures a tuner based on wireless communication performances (e.g., at least one of received signal quality or state information of reception paths) of the plurality of antennas. According to an example embodiment, the instructions, when executed by the at least one processor individually and/or collectively, to cause the electronic device to identify the wireless communication performances of the plurality of antennas in a state in which the tuner associated with the first antenna is configured based on the first tuning method. According to an example embodiment, the instructions, when executed by the at least one processor individually and/or collectively, to cause the electronic device to change the tuning method of the first antenna to a second tuning method that configures a tuner by considering the wireless communication performance of the first antenna in the case where a difference value in wireless communication performance between the first antenna and the second antenna (e.g., the second antenna 324 in FIG. 3) satisfies a designated first switching condition. According to an example embodiment, the instructions, when executed by the at least one processor individually and/or collectively, to cause the electronic device to configure the tuner associated with the second antenna based on the second tuning method.

According to an example embodiment, the instructions, when executed by the at least one processor individually and/or collectively, to cause the electronic device to determine that the designated first switching condition is satisfied when the wireless communication performance (e.g., at least one of received signal quality or state information of a reception path) of the first antenna is higher than the wireless communication performance of the second antenna by a designated reference difference value or more.

According to an example embodiment, the instructions, when executed by the at least one processor individually and/or collectively, to cause the electronic device to deactivate a reception path associated with the second antenna based on determining that the difference value in wireless communication performance (e.g., at least one of received signal quality or state information of a reception path) between the first antenna and the second antenna satisfies the designated first switching condition.

According to an example embodiment, the instructions, when executed by the at least one processor individually and/or collectively, to cause the electronic device to identify whether the wireless communication performance of the second antenna satisfies a designated second switching condition based on determining that the difference value in wireless communication performance (e.g., at least one of received signal quality or state information of a reception path) between the first antenna and the second antenna satisfies the designated first switching condition. According to an embodiment, the instructions, when executed by the at least one processor individually and/or collectively, to cause the electronic device to change the tuning method of the first antenna to the second tuning method, which is different from the first tuning method, based on determining that the designated second switching condition is satisfied.

According to an example embodiment, the instructions, when executed by the at least one processor individually and/or collectively, to cause the electronic device to determine that the designated second switching condition is satisfied when the reference signal received power (RSRP) of the second antenna is equal to or less than a reference RSRP and the signal to noise ratio (SNR) of the second antenna is less than a reference SNR.

According to an example embodiment, the instructions, when executed by the at least one processor individually and/or collectively, to cause the electronic device to deactivate a reception path associated with the second antenna based on determining that the wireless communication performance (e.g., at least one of the received signal quality or state information of a reception path) of the second antenna satisfies a designated second switching condition.

According to an example embodiment, the tuner associated with the first antenna may be positioned on an electric path between the at least one processor and the first antenna

According to an example embodiment, the tuner associated with the first antenna may include at least one of an impedance tuner and an aperture tuner.

According to an example embodiment, the instructions, when executed by the at least one processor individually and/or collectively, to cause the electronic device to identify the wireless communication performances of the plurality of antennas based on a designated period when the electronic device is located in a weak electric field area.

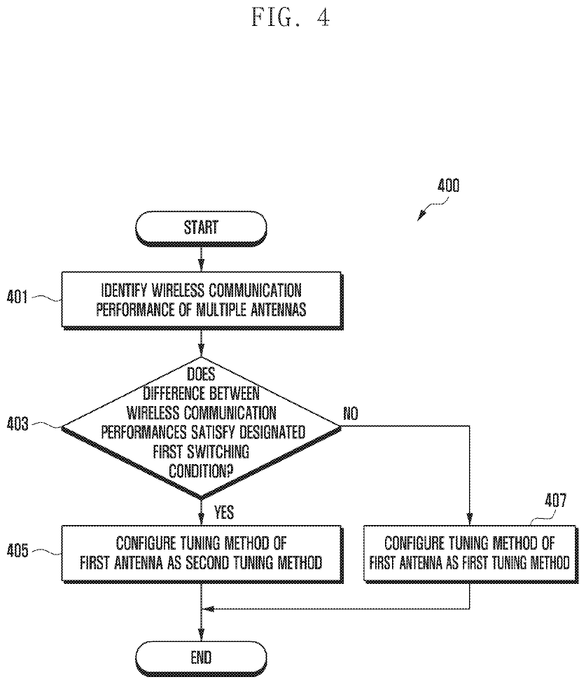

FIG. 4 is a flowchart 400 illustrating example operations for changing the tuning method of a first antenna in an electronic device according to various example embodiments. In the following examples, the operations may be performed sequentially, but are not necessarily performed sequentially. For example, the order of the operations may be changed, and at least two operations may be performed in parallel. For example, the electronic device in FIG. 4 may be the electronic device 101 in FIG. 1, FIG. 2, or FIG. 3.

According to an embodiment referring to FIG. 4, an electronic device (e.g., the electronic device 101 in FIG. 1, FIG. 2, or FIG. 3) or a processor (e.g., the processor 120 in FIG. 1 or the processor 300 in FIG. 3), in operation 401, may identify wireless communication performances of a plurality of antennas (e.g., the plurality of antennas 320 in FIG. 3) used for wireless communication. For example, when the electronic device 101 is in a weak electric field state during wireless communication via a plurality of antennas 320, the processor 300 may periodically identify the wireless communication performances of the respective antennas (e.g., the first antenna 322 and the second antenna 324), based on a designated first period. For example, the designated first period may be configured based on at least one of a period (e.g., approximately 200 ms) for updating a configuration value (e.g., tuning code) of a tuner or a paging period (e.g., approximately 320 ms or approximately 640 ms). For example, the weak electric field state is a state in which the wireless communication performance of the electronic device 101 satisfies designated weak electric field conditions, and may include a state in which the strength of a wireless signal received by the electronic device 101 is lower than a designated reference strength. For example, wireless communication performance may include at least one of the quality of a signal received through each antenna (e.g., the first antenna 322 or the second antenna 324) during a designated period of time, or state information of a reception path associated with each antenna.

For example, the processor 300 may control the communication circuit 310 to perform wireless communication in the state in which the configuration value of the tuner associated with the first antenna 322 is configured based on the first tuning method. For example, the first tuning method may include an active detuning method, which configures the tuner associated with the first antenna 322 in consideration of at least one of the wireless communication performances of the first antenna 322 and the second antenna 324 or the isolation between the first antenna 322 and the second antenna 324. For example, wireless communication is a communication method utilizing a plurality of antennas and may include at least one of long-term evolution (LTE) or new radio (NR).

According to an embodiment, in operation 403, the electronic device (e.g., the electronic device 101) or the processor (e.g., the processor 120 or 300) may identify whether a difference value in wireless communication performance among the plurality of antennas (e.g., the first antenna 322 and the second antenna 324 in FIG. 3) used for wireless communication satisfies a designated first switching condition. For example, the state in which the designated first switching condition is satisfied may include a state in which the wireless communication performance of the second antenna 322 is lower than the wireless communication performance of the first antenna 322 by a designated reference difference or more. For example, the state in which the designated first switching condition is satisfied may include a state in which a reception imbalance phenomenon has occurred between the first antenna 322 and the second antenna 324. For example, the state in which the designated first switching condition is not satisfied may include a state in which the wireless communication performance of the second antenna 324 is within a designated reference difference from the wireless communication performance of the first antenna 322.

According to an embodiment, when it is determined that the designated first switching condition is satisfied (e.g., “Yes” in operation 403), the electronic device (e.g., the electronic device 101) or the processor (e.g., the processor 120 or 300) may configure (or change) the tuning method of the tuner associated with the first antenna 322 to a second tuning method in operation 405. For example, when it is determined that the designated first switching condition is satisfied in the state in which the tuning method of the tuner associated with the first antenna 322 is configured to the first tuning method, the processor may change the tuning method of the tuner associated with the first antenna 322 to a second tuning method. For example, the second tuning method may include an active tuning method that configures the tuner associated with the first antenna 322 by considering the wireless communication performance of the first antenna 322. For example, the first antenna 322 may be an antenna (e.g., the main antenna) with the best wireless communication performance, among the plurality of antennas 320, and may be used for transmitting and receiving signals.

For example, if the processor 300 changes the tuning method of the tuner associated with the first antenna 322 to the second tuning method, the processor 300 may periodically update, based on a designated first period (e.g., approximately 200 ms), the configuration value (e.g., tuning code) of the tuner associated with the first antenna 322 based on the state information of a reception path (e.g., VSWR) associated with the first antenna 322. For example, the state information of a reception path associated with the first antenna 322 may be measured (or identified) based on a designated second period (e.g., approximately 50 ms) that is different from the designated first period. For example, the configuration value of a tuner associated with the first antenna 322 may be adaptively updated to correspond to a wireless communication environment.

According to an embodiment, when it is determined that the designated first switching condition is not satisfied (e.g., “No” in operation 403), the electronic device (e.g., the electronic device 101) or the processor (e.g., the processor 120 or 300) may configure the tuning method of the tuner associated with the first antenna 322 to the first tuning method in operation 407. For example, when it is determined that the designated first switching condition is not satisfied in the state in which the tuning method of the tuner associated with the first antenna 322 is configured to the first tuning method, the processor 300 may maintain the tuning method of the tuner associated with the first antenna 322 configured to the first tuning method. For example, when it is determined that the designated first switching condition is not satisfied in the state in which the tuning method of the tuner associated with the first antenna 322 is configured to the second tuning method, the processor 300 may change the tuning method of the tuner associated with the first antenna 322 to the first tuning method.

For example, when the processor 300 changes the tuning method of the tuner associated with the first antenna 322 to the first tuning method, the processor 300 may configure the tuner associated with the first antenna 322 to a fixed value configured based on the first tuning method. For example, the fixed value may include a value configured to maintain isolation from the second antenna 324 at a designated value (e.g., approximately 30 dB).

According to an embodiment, when the tuning method of the first antenna 322 is configured as the second tuning method, the electronic device 101 may have improved performance of transmission output (e.g., total radiated power (TRP)) and reception sensitivity (e.g., total isotropic sensitivity (TIS)) of the first antenna 322, as shown in Table 1 below. For example, Table 1 may include the transmission power and reception sensitivity of the first antenna 322 when the electronic device 101 performs LTE communication over a frequency band of B2 (e.g., approximately 1900 MHz).

TABLE 1

| | | |
|---|---|---|
| LTE B2 | First tuning method | Second tuning method |

| | | | | |
|---|---|---|---|---|
| TRP | 19.5 | dBm | 20.7 | dBm |
| TIS | −93.7 | dBm | −94.8 | dBm |

For example, the transmission power (TRP) and reception sensitivity (TIS) of the first antenna 322 when the configuration value of the tuner associated with the first antenna 322 is configured by the second tuning method may be improved compared to the transmission power (TRP) and reception sensitivity (TIS) of the first antenna 322 when the configuration value of the tuner associated with the first antenna 322 is configured by the first tuning method. For example, the state in which the configuration value of the tuner associated with the first antenna 322 is configured by the second tuning method may include a state in which the reception path associated with the second antenna 324 is deactivated. For example, the state in which the configuration value of the tuner associated with the first antenna 322 is configured by the first tuning method may include a state in which the reception path associated with the second antenna 324 is activated.

According to an embodiment, when it is determined that the designated first switching condition is satisfied (e.g., “Yes” in operation 403), the electronic device 101 may deactivate the reception path associated with the second antenna 324. For example, the deactivating of the reception path may include a series of operations of cutting off the power supply to at least one circuit of the reception path.

According to an embodiment, when the reception path associated with the second antenna 324 is in the deactivated state, the electronic device 101 may activate the reception path associated with the second antenna 324, based on determining that the designated first switching condition is not satisfied. For example, the activating of the reception path may include a series of operations of supplying power to circuits of the reception path and switching to a state capable of receiving signals through the reception path.

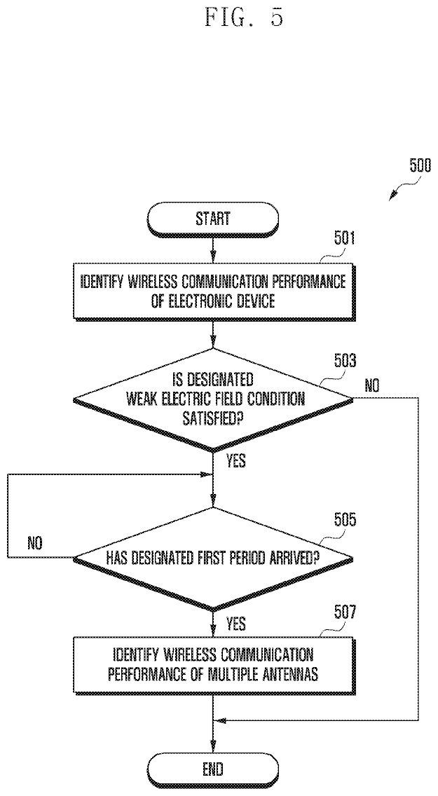

FIG. 5 is a flowchart 500 illustrating example operations for identifying the wireless communication performance of a plurality of antennas in an electronic device according to various example embodiments. For example, at least a portion in FIG. 5 may include detailed operations of operation 401 in FIG. 4. In the following examples, the operations may be performed sequentially, but are not necessarily performed sequentially. For example, the order of the operations may be changed, and at least two operations may be performed in parallel. For example, the electronic device in FIG. 5 may be the electronic device 101 in FIG. 1, FIG. 2, or FIG. 3.

According to an embodiment referring to FIG. 5, an electronic device (e.g., the electronic device 101 in FIG. 1, FIG. 2, or FIG. 3) or a processor (e.g., the processor 120 in FIG. 1 or the processor 300 in FIG. 3), when performing wireless communication via a plurality of antennas (e.g., the plurality of antennas 320 in FIG. 3), in operation 501, may identify the wireless communication performance of the electronic device 101. For example, the wireless communication performance of the electronic device 101 may be identified based on the wireless communication performances of the plurality of antennas 320.

According to an embodiment, the electronic device (e.g., the electronic device 101) or the processor (e.g., the processor 120 or 300) may identify whether the wireless communication performance of the electronic device 101 satisfies a designated weak electric field condition in operation 503. For example, the state in which the designated weak electric field condition is satisfied may include a state in which the wireless communication performance (e.g., received signal strength) of the electronic device 101 is lower than a designated reference performance. For example, the state in which the designated weak electric field condition is not satisfied may include a state in which the wireless communication performance (e.g., received signal strength) of the electronic device 101 is equal to or greater than a designated reference performance.

According to an embodiment, when it is determined that the designated weak electric field condition is not satisfied (e.g., “No” in operation 503), the electronic device (e.g., the electronic device 101) or the processor (e.g., the processor 120 or 300) may terminate identifying the wireless communication performance of the plurality of antennas. For example, when it is determined that the designated weak electric field condition is not satisfied, the processor 300 may determine that the electronic device 101 is located in a medium or strong electric field area. When it is determined that the electronic device 101 is located in a medium or strong electric field area, the processor 300 may determine that the wireless communication performance required by the electronic device 101 is able to be maintained through the plurality of antennas 320.

According to an embodiment, when it is determined that the designated weak electric field condition is satisfied (e.g., “Yes” in operation 503), the electronic device (e.g., the electronic device 101) or the processor (e.g., the processor 120 or 300), in operation 505, may determine whether a designated first period has arrived. For example, when it is determined that the designated weak electric field condition is satisfied, the processor 300 may determine that the electronic device 101 is located in a weak electric field area. When it is determined that the electronic device 101 is located in a weak electric field area, the processor 300 may determine whether a designated first period for identifying the wireless communication performance of each antenna (e.g., the first antenna 322 or the second antenna 324) has arrived in order to determine whether to continuously use the plurality of antennas 320. For example, the designated first period may be configured based on at least one of a period (e.g., approximately 200 ms) for updating the configuration value (e.g., tuning code) of the tuner in an RRC connected state, or a paging period (e.g., approximately 320 ms or approximately 640 ms) in an RRC idle state or an RRC inactive state.

According to an embodiment, if the designated first period has not arrived (e.g., “No” in operation 505), the electronic device (e.g., the electronic device 101) or the processor (e.g., the processor 120 or 300) may continue to determine whether the designated first period has arrived in operation 505. For example, if the processor 300 is performing wireless communication via the plurality of antennas 320, the processor 300 may periodically or continuously determine whether the designated first period has arrived.

According to an embodiment, when the designated first period has arrived (e.g., “Yes” in operation 505), the electronic device (e.g., the electronic device 101) or the processor (e.g., the processor 120 or 300) may identify the wireless communication performances of the plurality of antennas (e.g., the plurality of antennas 320 in FIG. 3) used for wireless communication in operation 507. For example, wireless communication performance may include at least one of the quality of a signal (or the average value of signal quality) received through each antenna (e.g., the first antenna 322 or the second antenna 324) during a designated period of time, or state information of a reception path associated with each antenna. For example, the signal quality may include at least one of a received signal strength indicator (RSSI), a reference signal received quality (RSRQ), a reference signal received power (RSRP), a signal to noise ratio (SNR), a signal to interference and noise ratio (SINR), a quality of service (QoS), or a bit error rate (BER).

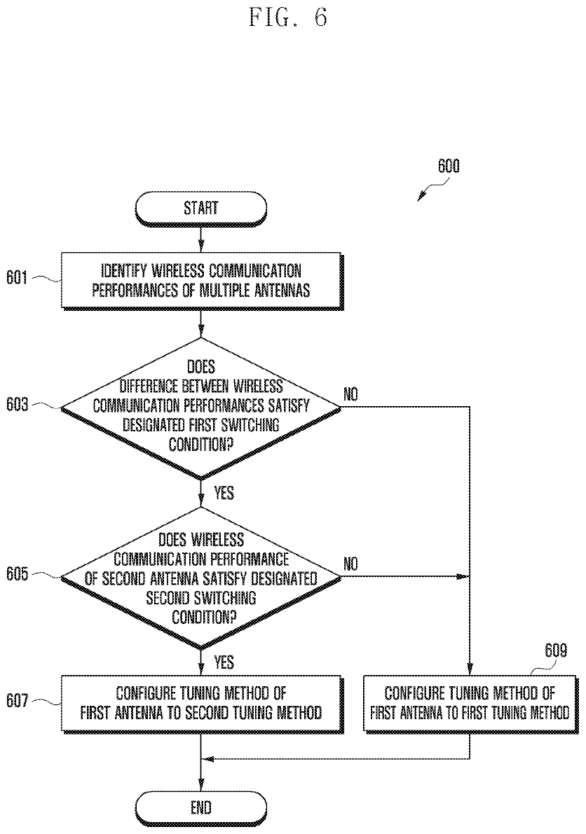

FIG. 6 is a flowchart 600 illustrating example operations for changing the tuning method of a first antenna in an electronic device according to various example embodiments. In the following examples, the operations may be performed sequentially, but are not necessarily performed sequentially. For example, the order of the operations may be changed, and at least two operations may be performed in parallel. For example, the electronic device in FIG. 6 may be the electronic device 101 in FIG. 1, FIG. 2, or FIG. 3.

According to an embodiment referring to FIG. 6, an electronic device (e.g., the electronic device 101 in FIG. 1, FIG. 2, or FIG. 3) or a processor (e.g., the processor 120 in FIG. 1 or the processor 300 in FIG. 3), when performing wireless communication via a plurality of antennas (e.g., the plurality of antennas 320 in FIG. 3), in operation 601, may identify the wireless communication performances of the plurality of antennas (e.g., the plurality of antennas 320 in FIG. 3). For example, the processor 300 may control the communication circuit 310 to perform wireless communication through the plurality of antennas 320 in the state where a configuration value of a tuner associated with the first antenna 322 is configured based on a first tuning method. For example, the first tuning method may include an active detuning method of configuring the tuner associated with the first antenna 322 in consideration of at least one of the wireless communication performances of the first antenna 322 and the second antenna 324 or the isolation between the first antenna 322 and the second antenna 324. For example, wireless communication is a communication method utilizing a plurality of antennas and may include at least one of long-term evolution (LTE) or new radio (NR).

For example, when the electronic device 101 is in a weak electric field state during wireless communication, the processor 300 may periodically identify the wireless communication performances of the respective antennas (e.g., the first antenna 322 and the second antenna 324) used in wireless communication, based on a designated first period. For example, the designated first period may be configured based on at least one of a period (e.g., approximately 200 ms) for updating a configuration value (e.g., tuning code) of the tuner or a paging period (e.g., approximately 320 ms or approximately 640 ms). For example, the weak electric field state is a state in which the wireless communication performance of the electronic device 101 satisfies designated weak electric field conditions, and may include a state in which the strength of a wireless signal received by the electronic device 101 is lower than a designated reference strength. For example, wireless communication performance may include at least one of the quality of a signal received through each antenna (e.g., the first antenna 322 or the second antenna 324) during a designated period of time, or state information of a reception path associated with each antenna.

According to an embodiment, the electronic device (e.g., the electronic device 101) or the processor (e.g., the processor 120 or 300) may identify whether a difference value in wireless communication performance among the plurality of antennas (e.g., the first antenna 322 and the second antenna 324 in FIG. 3) used for wireless communication satisfies a designated first switching condition in operation 603. For example, the state in which the designated first switching condition is satisfied indicates a state in which the wireless communication performance of the second antenna 324 is lower than the wireless communication performance of the first antenna 322 by a designated reference difference or more, and may include a state in which a reception imbalance phenomenon has occurred between the first antenna 322 and the second antenna 324. For example, the state in which the designated first switching condition is not satisfied indicates a state in which the wireless communication performance of the second antenna 324 is within a designated reference difference from the wireless communication performance of the first antenna 322, and may include a state in which a reception imbalance phenomenon has not occurred between the first antenna 322 and the second antenna 324.

According to an embodiment, when it is determined that the designated first switching condition is satisfied (e.g., “Yes” in operation 603), the electronic device (e.g., the electronic device 101) or the processor (e.g., the processor 120 or 300) may identify whether a designated second switching condition is satisfied based on the wireless communication performance of the second antenna 324 (e.g., MIMO antenna) in operation 605. For example, the state in which the designated second switching condition is satisfied may include a state in which the RSRP of the second antenna 324 is lower than or equal to a designated reference RSRP (e.g., approximately −125 dBm) and the SNR of the second antenna 324 is lower than or equal to a designated reference SNR (e.g., approximately 0). For example, the state in which the designated second switching condition is not satisfied may include a state in which the RSRP of the second antenna 324 exceeds a designated reference RSRP (e.g., approximately −125 dBm) or the SNR of the second antenna 324 exceeds a designated reference SNR (e.g., approximately 0). For example, the state in which the designated second switching condition is satisfied may include a state in which the rank indicator or rank index (RI) continuously or periodically transmitted by the electronic device 101 to the network is configured to a designated first configuration value (e.g., “1”). For example, the state in which the designated second switching condition is not satisfied may include a state in which the rank indicator or rank index (RI) continuously or periodically transmitted by the electronic device 101 to the network is configured to a designated second configuration value (e.g., “2”). For example, the RI of the designated second configuration value may include a state in which the plurality of antennas do not interfere with each other (or have no correlation).

For example, the second antenna 324 may be an auxiliary antenna for multi-antenna communication (e.g., multi-input multi-output (MIMO) or diversity) and may include an antenna physically adjacent to the first antenna 322. For example, the second antenna 324 may be used for receiving signals.

According to an embodiment, when it is determined that the designated second switching condition is satisfied (e.g., “Yes” in operation 605), the electronic device (e.g., the electronic device 101) or the processor (e.g., the processor 120 or 300) may configure the tuning method of the tuner associated with the first antenna 322 to the second tuning method in operation 607. For example, when the processor 300 determines that the designated second switching condition is satisfied, the processor may determine that the wireless communication performance of the second antenna 324 does not affect the wireless communication performance of the electronic device 101. The processor 300 may change the tuning method of the tuner associated with the first antenna 322 to the second tuning method based on determining that the wireless communication performance of the second antenna 324 does not affect the wireless communication performance of the electronic device 101. For example, the second tuning method may include an active tuning method that configures the tuner associated with the first antenna 322 by considering the wireless communication performance of the first antenna 322. For example, the first antenna 322 may be an antenna (e.g., the main antenna) with the best wireless communication performance, among the plurality of antennas 320, and may be used for transmitting and receiving signals.

For example, when the processor 300 changes the tuning method of the tuner associated with the first antenna 322 to the second tuning method, the processor 300 may periodically update, based on a designated first period (e.g., approximately 200 ms), the configuration value (e.g., tuning code) of the tuner associated with the first antenna 322 based on the state information of a reception path (e.g., VSWR) associated with the first antenna 322. For example, the state information of a reception path associated with the first antenna 322 may be measured (or identified) based on a designated second period (e.g., approximately 50 ms) that is different from the designated first period. For example, the configuration value of a tuner associated with the first antenna 322 may be adaptively updated to correspond to a wireless communication environment.

According to an embodiment, when it is determined that the designated first switching condition is not satisfied (e.g., “No” in operation 603), or when it is determined that the designated second switching condition is not satisfied (e.g., “No” in operation 605), the electronic device (e.g., the electronic device 101) or the processor (e.g., the processor 120 or 300) may configure the tuning method of the tuner associated with the first antenna 322 to the first tuning method in operation 609. For example, when it is determined that the designated first switching condition is not satisfied in the state in which the tuning method of the tuner associated with the first antenna 322 is configured to the first tuning method, the processor 300 may maintain the tuning method of the tuner associated with the first antenna 322 configured to the first tuning method. For example, when it is determined that the designated first switching condition is not satisfied in the state in which the tuning method of the tuner associated with the first antenna 322 is configured to the second tuning method, the processor 300 may change the tuning method of the tuner associated with the first antenna 322 to the first tuning method.

For example, when the processor 300 changes the tuning method of the tuner associated with the first antenna 322 to the first tuning method, the processor 300 may configure the tuner associated with the first antenna 322 to a fixed value configured based on the first tuning method. For example, the fixed value may include a value configured to maintain isolation from the second antenna 324 at a designated value (e.g., approximately 30 dB).

According to an embodiment, when it is determined that the designated first switching condition and the designated second switching condition are satisfied (e.g., “Yes” in operation 603 and “Yes” in operation 605), the electronic device 101 may deactivate the reception path associated with the second antenna 324. For example, the deactivating of the reception path may include a series of operations of cutting off the power supply to at least one circuit of the reception path.

For example, the electronic device 101 may deactivate the reception path associated with the second antenna 324, which is determined not to affect the wireless communication performance of the electronic device 101, thereby reducing unnecessary power consumption, as shown in Table 2. For example, Table 2 may include the current consumption of the electronic device 101 when the electronic device 101 performs LTE communication over a frequency band of B2 (e.g., approximately 1900 MHz).

TABLE 2

| | Second antenna reception | Second antenna reception |
|---|---|---|
| LTE B2 | path ON | path OFF |
| Current | 885 mA | 860 mA |
| Consumption | | |

For example, the current consumed by the electronic device 101 for wireless communication in the state in which the reception path associated with the second antenna 324 is deactivated (e.g., the reception path of the second antenna is OFF) may be lower than the current consumed by the electronic device 101 for wireless communication in the state in which the reception path associated with the second antenna 324 is activated (e.g., the reception path of the second antenna is ON).

According to an embodiment, when the reception path associated with the second antenna 324 is deactivated, the electronic device 101 may activate the reception path associated with the second antenna 324, based on determining that the designated first switching condition or the designated second switching condition is not satisfied. For example, the activating of the reception path may include a series of operations of supplying power to circuits of the reception path and switching to a state capable of receiving signals through the reception path.

According to an example embodiment, method of operating an electronic device (e.g., the electronic device 101 in FIG. 1, FIG. 2, or FIG. 3) including a plurality of antennas (e.g., the antenna module 197 in FIG. 1 or the plurality of antennas 320 in FIG. 3) physically arranged adjacent to each other may include configuring a tuner associated with a first antenna (e.g., the first antenna 322 in FIG. 3) among the plurality of antennas using a first tuning method that configures a tuner based on wireless communication performances (e.g., at least one of received signal quality or state information of reception paths) of the plurality of antennas. According to an example embodiment, the method may include identifying the wireless communication performances of the plurality of antennas in a state in which the tuner associated with the first antenna is configured based on the first tuning method. According to an example embodiment, the method may include changing the tuning method of the first antenna to a second tuning method that configures a tuner by considering the wireless communication performance of the first antenna when a difference value in wireless communication performance between the first antenna and the second antenna (e.g., the second antenna 324 in FIG. 3) satisfies a designated first switching condition. According to an example embodiment, the method may include configuring the tuner associated with the second antenna based on the second tuning method.

According to an example embodiment, the method may include determining that the designated first switching condition is satisfied when the wireless communication performance (e.g., at least one of received signal quality or state information of a reception path) of the first antenna is higher than the wireless communication performance of the second antenna by a designated reference difference value or more.

According to an example embodiment, the method may include deactivating a reception path associated with the second antenna based on determining that the difference value in wireless communication performance (e.g., at least one of received signal quality or state information of a reception path) between the first antenna and the second antenna satisfies the designated first switching condition.

According to an example embodiment, the changing to the second tuning method may include identifying whether the wireless communication performance of the second antenna satisfies a designated second switching condition based on determining that the difference value in wireless communication performance (e.g., at least one of received signal quality or state information of a reception path) between the first antenna and the second antenna satisfies the designated first switching condition, and, based on determining that the designated second switching condition is satisfied, changing the tuning method of the first antenna 322 to the second tuning method.

According to an example embodiment, the method may include determining that the designated second switching condition is satisfied when the reference signal received power (RSRP) of the second antenna is equal to or less than a reference RSRP and the signal to noise ratio (SNR) of the second antenna is less than a reference SNR.

According to an example embodiment, the method may include deactivating a reception path associated with the second antenna based on determining that the wireless communication performance (e.g., at least one of the received signal quality or state information of a reception path) of the second antenna satisfies a designated second switching condition.

According to an example embodiment, the identifying of the wireless communication performance may include identifying the wireless communication performances of the plurality of antennas based on a designated period when the electronic device is located in a weak electric field area.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. An electronic device comprising:
a plurality of antennas physically arranged adjacent to each other;
at least one processor, comprising processing circuitry, operatively connected to the plurality of antennas; and
memory storing instructions;
wherein the instructions, when executed by at least one processor individually and/or collectively, cause the electronic device to:
identify at least one of received signal quality of the plurality of antennas and/or state information of reception paths associated with the plurality of antennas;
configure a tuner associated with a first antenna among the plurality of antennas using a first tuning method that configures a tuner based on at least one of the identified received signal quality of the plurality of antennas and/or the identified state information of reception paths of the plurality of antennas;
identify at least one of the received signal quality of the plurality of antennas and/or the state information of reception paths of the plurality of antennas in a state in which the tuner associated with the first antenna is configured based on the first tuning method;
change the tuning method of the first antenna to a second tuning method that configures a tuner based on at least one of received signal quality of the first antenna and/or state information of a reception path of the first antenna based on a difference value in at least one of received signal quality and/or state information of a reception path between the first antenna and the second antenna satisfying a designated first switching condition; and
configure the tuner associated with the second antenna based on the second tuning method.

2. The electronic device of claim 1,
wherein the instructions, when executed by at least one processor, individually and/or collectively, cause the electronic device to deactivate a reception path associated with the second antenna based on determining that the difference value in at least one of received signal quality and/or state information of a reception path between the first antenna and the second antenna satisfies the designated first switching condition.

3. The electronic device of claim 1,
wherein the instructions, when executed by at least one processor, individually and/or collectively, cause the electronic device to:
identify whether at least one of received signal quality of the second antenna and/or state information of a reception path of the second antenna satisfies a designated second switching condition based on determining that the difference value in at least one of received signal quality or state information of a reception path between the first antenna and the second antenna satisfies the designated first switching condition; and
based on determining that the designated second switching condition is satisfied, change the tuning method of the first antenna to the second tuning method, different from the first tuning method.

4. The electronic device of claim 3,
wherein the instructions, when executed by at least one processor, individually and/or collectively, cause the electronic device to deactivate a reception path associated with the second antenna based on determining that at least one of the received signal quality of the second antenna and/or the state information of the reception path of the second antenna satisfies the designated second switching condition.

5. The electronic device of claim 1,
wherein the tuner associated with the first antenna is positioned between at least one processor and the first antenna.

6. The electronic device of claim 1,
wherein the tuner associated with the first antenna comprises at least one of an impedance tuner and/or an aperture tuner.

7. The electronic device of claim 1,
wherein the instructions, when executed by at least one processor, individually and/or collectively, cause the electronic device to identify at least one of the received signal quality of the plurality of antennas or the state information of reception paths of the plurality of antennas based on a designated period while the electronic device is located in a weak electric field area.

8. The electronic device according to claim 7,
wherein the designated period is configured based on at least one of a period for updating a configuration value of the tuner and/or a paging period.

9. A method of operating an electronic device comprising a plurality of antennas physically arranged adjacent to each other, the method comprising:
identifying at least one of received signal quality of the plurality of antennas and/or state information of reception paths associated with the plurality of antennas;
configuring a tuner associated with a first antenna among the plurality of antennas using a first tuning method that configures a tuner based on at least one of the identified received signal quality of the plurality of antennas and/or the identified state information of reception paths of the plurality of antennas;
identifying at least one of the received signal quality of the plurality of antennas and/or the state information of reception paths of the plurality of antennas in a state in which the tuner associated with the first antenna is configured based on the first tuning method;
changing the tuning method of the first antenna to a second tuning method that configures a tuner based on at least one of received signal quality of the first antenna and/or state information of a reception path of the first antenna based on a difference value in at least one of received signal quality and/or state information of a reception path between the first antenna and the second antenna satisfying a designated first switching condition; and
configuring the tuner associated with the second antenna based on the second tuning method.

10. The method of claim 9, further comprising
deactivating a reception path associated with the second antenna based on determining that the difference value in at least one of received signal quality and/or state information of a reception path between the first antenna and the second antenna satisfies the designated first switching condition.

11. The method of claim 9,
wherein the changing to the second tuning method comprises:
identifying whether at least one of received signal quality of the second antenna and/or state information of a reception path of the second antenna satisfies a designated second switching condition based on determining that the difference value in at least one of received signal quality or state information of a reception path between the first antenna and the second antenna satisfies the designated first switching condition; and
based on determining that the designated second switching condition is satisfied, changing the tuning method of the first antenna to the second tuning method, different from the first tuning method.

12. The method of claim 11, further comprising
deactivating a reception path associated with the second antenna based on determining that at least one of the received signal quality of the second antenna and/or the state information of the reception path of the second antenna satisfies the designated second switching condition.

13. The method of claim 9,
wherein the identifying at least one of the received signal quality or the state information of a reception path comprises
identifying at least one of the received signal quality of the plurality of antennas and/or the state information of reception paths of the plurality of antennas based on a designated period while the electronic device is located in a weak electric field area.

14. The method of claim 13,
wherein the designated period is configured based on at least one of a period for updating a configuration value of the tuner and/or a paging period.

15. The method of claim 9,
wherein the first tuning method comprises an active detuning method, and
wherein the second tuning method comprises an active tuning method.

16. The method of claim 9,
wherein the tuner associated with the first antenna comprises at least one of an impedance tuner and/or an aperture tuner.

17. One or more non-transitory computer-readable storage media storing one or more computer programs including computer-executable instructions that, when executed by at least one processor of an electronic device individually and/or collectively, cause the electronic device to perform operations, the operations comprising:
identifying at least one of received signal quality of the plurality of antennas and/or state information of reception paths associated with the plurality of antennas;
configuring a tuner associated with a first antenna among the plurality of antennas using a first tuning method that configures a tuner based on at least one of the identified received signal quality of the plurality of antennas and/or the identified state information of reception paths of the plurality of antennas;
identifying at least one of the received signal quality of the plurality of antennas and/or the state information of reception paths of the plurality of antennas in a state in which the tuner associated with the first antenna is configured based on the first tuning method;
changing the tuning method of the first antenna to a second tuning method that configures a tuner based on at least one of received signal quality of the first antenna and/or state information of a reception path of the first antenna based on a difference value in at least one of received signal quality and/or state information of a reception path between the first antenna and the second antenna satisfying a designated first switching condition; and
configuring the tuner associated with the second antenna based on the second tuning method.

18. One or more non-transitory computer-readable storage media of claim 17, further comprising
deactivating a reception path associated with the second antenna based on determining that the difference value in at least one of received signal quality and/or state information of a reception path between the first antenna and the second antenna satisfies the designated first switching condition.

19. One or more non-transitory computer-readable storage media of claim 17, wherein the changing to the second tuning method comprises:
identifying whether at least one of received signal quality of the second antenna and/or state information of a reception path of the second antenna satisfies a designated second switching condition based on determining that the difference value in at least one of received signal quality or state information of a reception path between the first antenna and the second antenna satisfies the designated first switching condition; and
based on determining that the designated second switching condition is satisfied, changing the tuning method of the first antenna to the second tuning method, different from the first tuning method.

20. One or more non-transitory computer-readable storage media of claim 19, further comprising
deactivating a reception path associated with the second antenna based on determining that at least one of the received signal quality of the second antenna and/or the state information of the reception path of the second antenna satisfies the designated second switching condition.
